(19) United States
(12) Patent Application Publication
(10) Pub. No.: US 2025/0207926 A1
(43) Pub. Date: Jun. 26, 2025

(54) Method for Supporting a Driver of a Vehicle When Traversing a Specified Route Segment in Road Traffic, Computing Device for a Vehicle, Computer-Readable (Storage) Medium, and Assistance System for a Vehicle

(71) Applicant: Bayerische Motoren Werke Aktiengesellschaft, Muenchen (DE)

(72) Inventors: Martin SEDLMAYR, Wessobrunn (DE); Hubert SCHOLZ, Muenchen (DE)

(21) Appl. No.: 18/847,720

(22) PCT Filed: Mar. 8, 2023
(86) PCT No.: PCT/EP2023/055827

§ 371 Date: Sep. 17, 2024

(30) Foreign Application Priority Data
Apr. 13, 2022 (DE) 10 2022 109 155.4

(51) Int. Cl. G01C 21/34

(52) U.S. Cl. CPC G01C 21/3453

(57) ABSTRACT

A method is provided for supporting a driver of a vehicle when traversing a specified route segment in road traffic has the steps of receiving racing line data which describes a driving path of the vehicle in a region of the specified route segment, the driving path additionally running within a lane; receiving surroundings data which describes the surroundings of the vehicle, wherein the driving path described by the racing lines runs through the surroundings; determining at least one characteristic route segment point using the racing lines in the surroundings data; locating the at least one characteristic route segment point with respect to the relative position of the vehicle; and providing relative position data which describes the position of the vehicle relative to the at least one characteristic route segment point.

### BACKGROUND AND SUMMARY

The present invention relates to a method for assisting a driver of a vehicle when traveling on a predetermined route course in road traffic. In addition, the present invention relates to a computing device for a vehicle for performing such a method. The present invention further relates to a computer-readable (storage) medium and to an assistance system for a vehicle.

In motor racing or in motor sport, the ideal line represents an imaginary line that describes the fastest possible path. In this context, the ideal line rarely constitutes the shortest path through a bend. The strategy of the fastest line is rather to enlarge the bend radius and to re-accelerate out of the bend as early as possible. In road traffic, given a sufficiently wide lane, the driver of a vehicle often chooses an ideal line to reduce the lateral acceleration and consequently the forces acting on the passengers of the vehicle when traveling round the bend. Regardless of whether the driver of the vehicle wants to drive in the most comfortable or most sporty fashion, it can be helpful to assist the driver of the vehicle within the applicable traffic regulations when traveling on a route course containing bends.

The idea of displaying to the driver of the vehicle an ideal line in a manner familiar from video games and/or racing simulators, for example, appears frequently in the literature. Such technologies, however, have not yet managed to move beyond the prototype stage into production vehicles. The reason for this is that, an accurate display of the ideal line, the vehicle position is normally generated by means of a fixed local global positioning system (GPS). However, this requires highly accurate position-finding, which is possible, for example, only using what is known as a differential global positioning system (D-GPS). This is not available in the public road transport system, however. Consequently, certain inaccuracies arise in the vehicle position. These and further inaccuracies mean that displaying the ideal line is not viable.

Document DE 10 2016 100 531 A1 provides a method for visualizing an ideal line along a route, having the following features: the route is detected by a road vehicle; the ideal line is calculated based on the detected route; and the calculated ideal line is added to a visual perception of the route from the road vehicle. In addition, a corresponding apparatus, a corresponding computer program and a corresponding (storage) medium are provided.

Laid-open specification DE 102016 100 531 A1 provides a method for visualizing an ideal line along a route, having the following features: the route is detected by a road vehicle; the ideal line is calculated based on the detected route; and the calculated ideal line is added to a visual perception of the route from the road vehicle. In addition, a corresponding apparatus, a corresponding computer program and a corresponding storage medium are provided in the document.

Document DE 102015 115666 A1 describes a system and a method that act as a performance driving tool and provide feedback to a driver, such as real-time visual feedback delivered via an augmented reality device. According to one embodiment, the performance driving system gathers pertinent vehicle information and driver information (e.g., the direction of the driver's gaze as determined by a wearable head-mounted-display (HMD)) and uses these inputs to generate real-time visual feedback in the form of virtual driving lines and other driving recommendations. These driving recommendations can be presented to the driver via an augmented reality device, such as a head-up-display (HUD), where the virtual driving lines are projected onto the vehicle windshield so that they are superimposed on top of the actual road surface seen by the driver and can show the driver a suggested line or path to take. Other driving recommendations, like braking, acceleration, steering and shifting suggestions, can also be made.

The object of the present invention is to provide a solution that makes it possible to improve a method for assisting a driver of a vehicle when traveling on a predetermined route course in road traffic. In particular, it is the object of the present invention to provide a solution that makes it possible to assist the driver in a simple manner when traveling on an ideal line in road traffic.

This object is achieved according to the invention by a method, by a computing device, by a computer-readable (storage) medium, and by an assistance system for a vehicle, having the features according to the independent claims. The dependent claims define advantageous developments of the present invention.

A method according to the invention for assisting a driver of a vehicle when traveling on a predetermined route course in road traffic comprises receiving ideal-line data, which describes a travel path of the vehicle in a region of the predetermined route course, wherein the travel path runs additionally within a lane. In addition, the method according to the invention comprises receiving surroundings data, which describes a surrounding area of the vehicle, through which surrounding area runs the travel path described by the ideal-line data. The method further comprises determining at least one characteristic route-course point on the basis of the ideal-line data and the surroundings data. The method also comprises localizing the at least one characteristic route-course point in terms of a relative position of the vehicle. The method finally comprises providing relative-position data, which describes the relative position of the vehicle in relation to the at least one characteristic route-course point. The providing of the relative-position data is performed here in such a way that the relative-position data describes the relative position of the vehicle in relation to the at least one characteristic route-course point by means of a predicted lateral distance. The predicted lateral distance describes a distance between the vehicle and the at least one characteristic route-course point expected between the vehicle and the at least one characteristic route-course point when the at least one characteristic route-course point is passed.

Thus, in the method according to the invention, ideal-line data is received. This ideal-line data describes the travel path of the vehicle along the predetermined route course. The travel path can be represented here as a trajectory, for example. It is also conceivable, however, that the travel path is represented in the form of individual discrete points. Alternatively or additionally, it is possible that the travel path is also represented in the form of straight lines, clothoids (curves with a linear change in curvature), curves of constant curvature, and/or suchlike. The ideal-line data preferably describes a travel path that complies with the road traffic regulations. In particular, the travel path described by the ideal-line data can lie within a lane. Cutting the bend, where the vehicle finds itself partially and/or temporarily on the opposite lane, can hence be avoided. In addition, surroundings data is received. This surroundings data can be provided by a camera and/or a lidar sensor, for example. The surroundings data describes the surrounding area of the vehicle and consequently at least a portion of the predetermined route course. It is also advantageous if the surroundings data describes the lane in as much detail as possible.

The ideal-line data and the surroundings data can thus be used to determine at least one characteristic route-course point. In other words, the ideal line, which is described by the ideal-line data, can thus be reduced to at least one characteristic route-course point. Hence, for instance, the ideal line can be reduced to the entry to the bend, the apex, and the exit from the bend.

Then, the characteristic route-course points, or the at least one characteristic route-course point, can be localized in terms of the relative position of the vehicle. In other words, the at least one route-course point can hence be described within a coordinate system of the vehicle. Finally, the relative-position data can be provided. The relative-position data describes a predicted lateral distance between the at least one characteristic route-course point and the relative position of the vehicle.

For example, if a characteristic route-course point is located in the lateral direction one meter to the side of the vehicle, and in the longitudinal direction ten meters in front of the vehicle, then the predicted lateral distance can equal one meter, if the vehicle is driving straight ahead. The predicted lateral distance can also change, however, if a steering angle of the vehicle does not equal 0°. In other words, the predicted lateral distance is not necessarily equal to the current lateral distance. Instead, the predicted lateral distance describes the distance between the vehicle and the at least one characteristic route-course point when the at least one characteristic route-course point is passed. Since this may not be known yet, the predicted lateral distance is the expected lateral distance.

The invention is based on the idea that the ideal line is reduced to distinct and easy-to-determine points along the route course. Hence, given a sufficiently wide lane, the driver of the vehicle can be assisted with traveling around a bend within the applicable road traffic regulations. The driver of the vehicle can thus be offered a sporty driving experience, but also a safety-oriented driving experience based on lower centrifugal forces. In particular, exact localization of the vehicle on the ideal line or along the travel path described by the ideal-line data can thus be avoided. Consequently, it is possible to dispense with employing a differential global positioning system (D-GPS), because the ideal line or the travel path can be reduced to a few points along the route course.

A further advantageous embodiment provides that feedback data is additionally provided, which describes the passing of the at least one characteristic route-course point. The feedback data can be used, for example, to signal to the driver of the vehicle if he has passed one of the at least one characteristic route-course points. In particular, the driver can thus be notified of changing characteristic route-course points. For example, the focus of the driver can hence be drawn from the characteristic route-course point describing the entrance to the bend to the route-course point describing the apex of the bend. This can provide additional assistance to the driver of the vehicle when traveling on the predetermined route course in road traffic.

In addition, it can be advantageous if the feedback data also describes an additional lateral distance between the vehicle and the at least one characteristic route-course point when the at least one characteristic route-course point is passed. By means of the actual lateral distance, the driver of the vehicle can be provided with feedback about how close he was, or is, to the ideal line, which is reduced to the characteristic route-course points. Using such feedback data, it is thus also possible to train the driver, or to provide him with suggestions for improving his driving style when traveling on the ideal line.

A further aspect of the invention relates to a computing device, which is designed to perform a method according to the invention and the advantageous embodiments thereof. The computing device can be in the form of an electronic control unit, which preferably comprises one or more programmable processors. In addition, the invention relates to a computer-readable (storage) medium comprising commands which, when executed by a computing device, cause this computing device to perform a method according to the invention and the advantageous embodiments thereof. The present invention relates to a computer program comprising commands which, when the program is executed by a computing device, cause this computing device to perform a method according to the invention and the advantageous embodiments thereof.

Finally, the present invention relates to an assistance system for a vehicle. The assistance system comprises a computing device, which is designed to perform a method according to the invention and the advantageous embodiments thereof. In addition, the assistance system comprises a computer-readable (storage) medium comprising commands which, when executed by the computing device, cause this computing device to perform the method according to the invention and the advantageous embodiments thereof. Finally, the assistance system comprises a notification apparatus, which is designed to inform the driver of the vehicle, based on the relative-position data and/or the feedback data, about the predicted lateral distance and/or the actual lateral distance and/or about the passing of the at least one characteristic route-course point.

It is also advantageous if the notification apparatus is in the form of an acoustic, visual and/or haptic notification apparatus. In other words, the notification apparatus can be a display, individual light emitting diodes, for instance in an instrument cluster, or suchlike. In particular, it may be what is known as a head-up display (HUD). Such a head-up display can be in the form of an augmented reality head-up display (AR-HUD), as it is known. Furthermore, alternatively or additionally, the notification apparatus can be in the form of a loudspeaker. It is also conceivable that the notification apparatus is designed alternatively or additionally to output haptic feedback. For example, such haptic feedback can be a vibrating steering wheel, a vibrating seat, a vibrating accelerator pedal, or the like.

A further advantageous embodiment provides that the notification apparatus is designed to inform the driver about the predicted lateral distance and/or the actual lateral distance by means of simulated road feedback. In other words, during the passing of the at least one characteristic route-course point, synthesized or simulated road feedback can be output by means of the notification apparatus and according to the relative-position data and/or the feedback data. If, for example, the actual lateral distance at the apex of the bend as the at least one characteristic route-course point equals only a few centimeters or even zero centimeters, then a feeling as though the driver were traveling on a curb of a racetrack can be conveyed to the driver in the form of certain vibrations by means of the (haptic) notification apparatus. Simulated road feedback can be conveyed, for example, by means of a vibrating steering wheel, a vibrating seat, and/or by means of a vibrating accelerator pedal/brake pedal.

An advantageous development provides that the assistance system comprises a driving-style analysis apparatus, which is designed to record and/or analyze the relative-position data and/or the feedback data during travel on the predetermined route course. Such a driving-style analysis apparatus allows the driver to be trained systematically, and to be assisted (in accordance with his driving style) when traveling on a predetermined route course in road traffic along an ideal line.

In addition, the driver of the vehicle can be motivated to use the assistance system. Such motivation can be implemented, for example, in the form of awards and/or unlocking of tutorials, functions, or the like. In addition, the driver can be motivated towards smooth and/or safety-orientated driving behavior.

A further aspect of the invention relates to a vehicle, in particular an automobile, comprising an assistance system according to the invention.

The preferred embodiments and their advantages presented with regard to the method according to the invention apply correspondingly to the computing device according to the invention, to the computer-readable (storage) medium according to the invention, to the computer program according to the invention, to the assistance system according to the invention, and to the vehicle according to the invention.

The claims, the figures and the description of the figures contain further features of the invention. The features and feature combinations mentioned above in the description, and features and feature combinations mentioned below in the description of the figures and/or shown solely in the figures can be used not just in the particular combination stated but also in other combinations or alone without departing from the scope of the present invention. The invention is described in greater detail below using preferred exemplary embodiments with reference to the accompanying drawings, in which:

### BRIEF DESCRIPTION OF THE DRAWINGS

FIG. 1 shows a schematic representation of a vehicle comprising an assistance system according to the invention;

FIG. 2 shows a schematic representation of a vehicle while traveling on an ideal line, which is reduced to three characteristic route-course points;

FIG. 3 shows a schematic representation of a vehicle while traveling on an ideal line analogous to FIG. 2, where the actual travel path deviates from the ideal line;

FIG. 4 shows a schematic representation of a driver's view while traveling on an ideal line according to FIG. 2, with the vehicle comprising a visual notification apparatus in the form of an augmented reality head-up display (AR-HUD);

FIG. 5a shows a schematic representation of a driver's view at the entrance to the bend according to FIG. 3, with the vehicle comprising a visual notification apparatus in the form of an augmented reality head-up display (AR-HUD) for visualizing feedback data;

FIG. 5b shows a schematic representation of a driver's view at the entrance to the bend according to FIG. 2, with the vehicle comprising a visual notification apparatus in the form of an augmented reality head-up display (AR-HUD) for visualizing feedback data; and

FIG. 5c shows a schematic representation of a driver's view at the apex according to FIG. 2, with the vehicle comprising a visual notification apparatus for displaying feedback data.

### DETAILED DESCRIPTION OF THE DRAWINGS

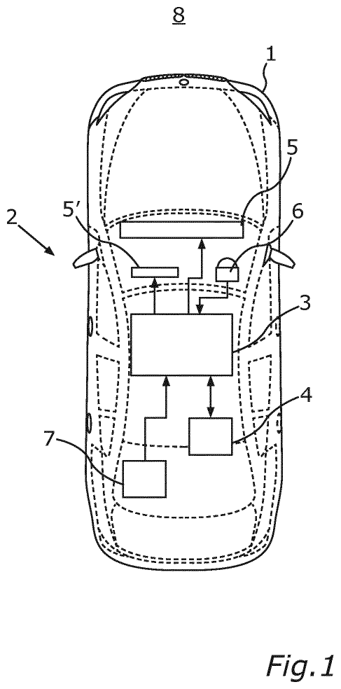

FIG. 1 shows a schematic representation of a vehicle 1 comprising an assistance system 2 according to the invention. The assistance system 2 comprises a computing device 3, a computer-readable (storage) medium 4 and a notification apparatus 5, shown schematically here as an augmented reality head-up display (AR-HUD). In addition, the vehicle 1 comprises a surround sensor 6. The surround sensor 6 can be used to provide surroundings data describing a surrounding area 8 of the vehicle 1. The vehicle 1 also comprises a global positioning system 7 (GPS) and a further notification apparatus 5′, shown schematically here as a haptic notification apparatus in the form of a steering wheel.

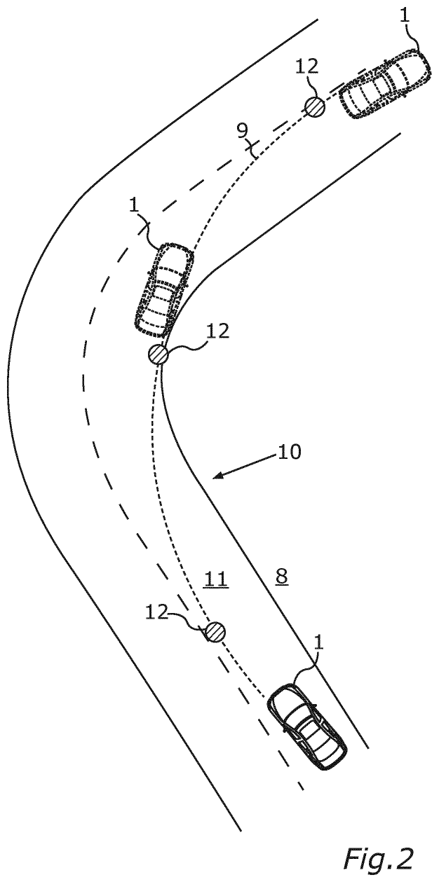

FIG. 2 shows a vehicle 1 while traveling on an ideal line or travel path 9 in a region of a predetermined route course 10. The travel path 9 or ideal line here runs within a lane 11. In addition, the position of the vehicle 1 is shown at different times: shortly before entering the bend, shortly after the apex, and shortly after exiting the bend.

The ideal line or travel path 9 can be reduced by means of the assistance system 2 to (abovementioned) three characteristic route-course points 12. The characteristic route-course points 12 can hence describe in particular an entrance to a bend, an apex, and an exit from a bend by the ideal line or travel path 9. FIG. 2 shows the vehicle 1 at different times while traveling on the ideal line or travel path 9. The vehicle 1 is consistently shown here as passing the characteristic route-course points 12 in an ideal manner, i.e., at an actual lateral distance of 0 cm.

The predetermined route course 10 can be predetermined on the basis of the natural course of the road, for example. It is also conceivable, that the predetermined route course 10 is predefined on the basis of a desired navigation destination of the driver of the vehicle 1. The ideal line or travel path 9 is located optimally always within the lane 11. This means that applicable road traffic act regulations can always be satisfied.

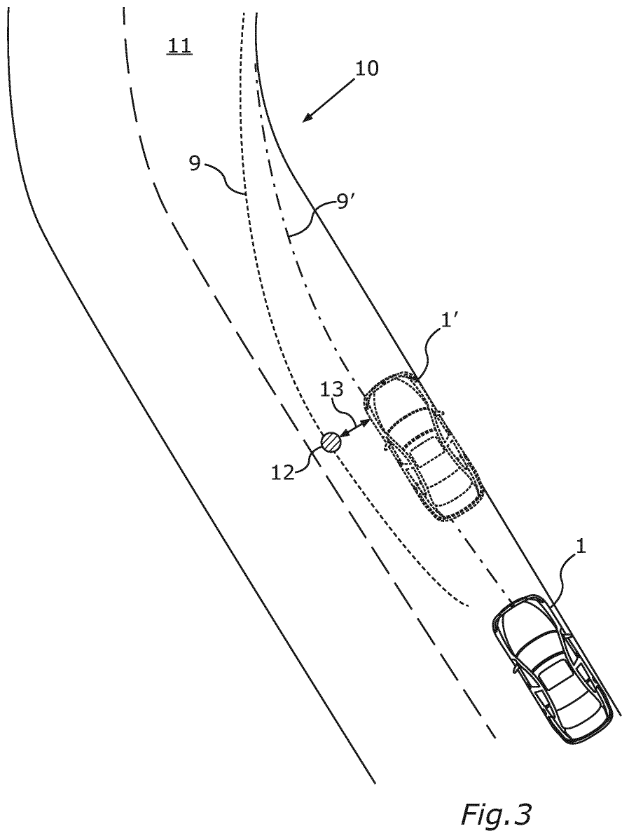

FIG. 3 shows in a schematic representation a vehicle 1 while traveling on an ideal line or travel path 9. The situation here is comparable to the situation depicted in FIG. 2. Unlike FIG. 2, the actual travel path 9′ in FIG. 3 deviates from the ideal line, described by the ideal-line data, or travel path 9. In order to assist the driver of the vehicle 1 while traveling on the predetermined route course 10, the predicted lateral distance 13 can be determined. However, the vehicle 1 is not yet necessarily at the location of the characteristic route-course point 12. In other words, the predicted lateral distance 13 between the characteristic route-course point 12 and the vehicle 1 when passing the characteristic route-course point 12 can be estimated. This can be done by predicting the position of the vehicle 1. The prediction of the vehicle position 1 when passing the characteristic route-course point 12 is depicted in FIG. 3 by the predicted vehicle 1′. The position of the predicted vehicle 1′ can depend, for example, on a steering angle and a current orientation of the vehicle 1.

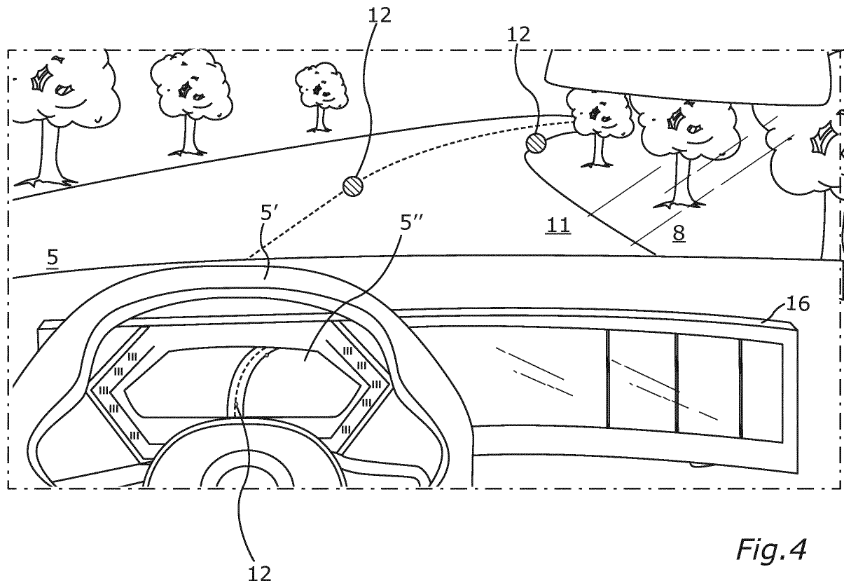

FIG. 4 shows a schematic representation of a driver's view while traveling on an ideal line according to FIG. 2, with the vehicle 1 comprising a (visual) notification apparatus 5 in the form of an augmented reality head-up display (AR-HUD). In other words, FIG. 4 shows the view of the driver through the windshield of the vehicle 1, which comprises an augmented reality head-up display (AR-HUD). In addition, the vehicle 1 comprises a haptic notification apparatus 5′, which is in the form of a steering wheel. The vehicle 1 further comprises a curved display 16, which can present a further (visual) notification apparatus 5″. The further (visual) notification apparatus 5″ can depict, for example, the predetermined route course 10 including the ideal line and/or the characteristic route-course points 12. In particular, a predetermined route course 10 can thus be visualized even though it is not yet visible at all to the driver through a windshield. For example, the driver of the vehicle 1 can thus be prepared already for a future route section including the ideal line 9 and its associated characteristic route-course points 12.

The relative-position data can be used to display to the driver of the vehicle 1 the characteristic route-course points 12 through the (visual) notification apparatus 5 in the form of the augmented reality head-up display (AR-HUD). The characteristic route-course points 12 can thereby be projected to the driver directly into the field of view and/or onto the roadway. It is possible here to depict the characteristic route-course points 12 in many different ways. For instance, it is conceivable that the characteristic route-course points 12 are depicted as simple points (as depicted in FIG. 4) but also as curbs familiar from motor racing. Depending on the predicted lateral distance 13, different notifications or information can be output to the driver of the vehicle 1 by means of the notification apparatus 5, the haptic notification apparatus 5′, and/or by means of the further (visual) notification apparatus 5″. Hence it is also possible to simulate for the driver of the vehicle 1 a certain driving experience, for instance a racetrack experience. It is conceivable here that first a visual simulation is carried out by projecting a curb at a position of a characteristic route-course point 12, so that subsequently when traveling on the curb (when passing the characteristic route-course point 12), a haptic simulation is carried out on the basis of a vibration of the haptic notification apparatus 5′.

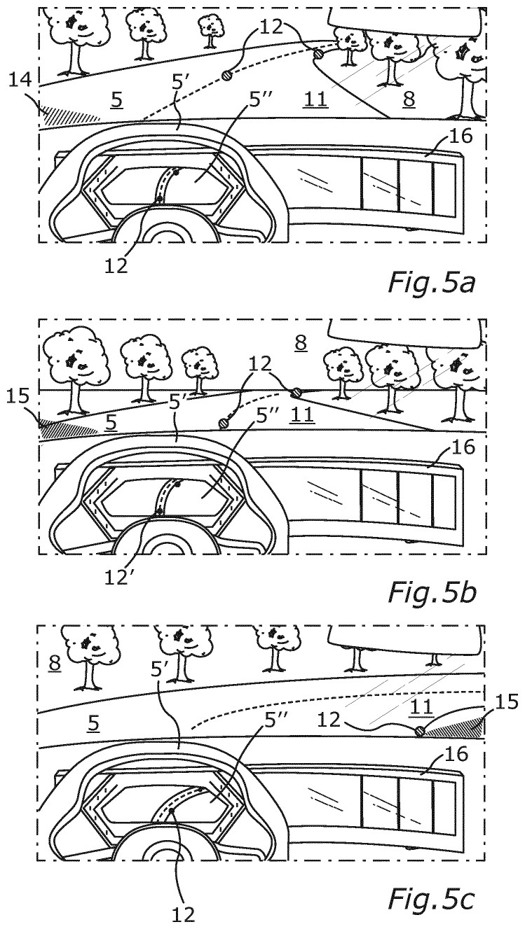

FIG. 5a shows a schematic representation of a driver's view at the entrance to the bend according to FIG. 3. This is comparable to the representation already given in FIG. 4. FIG. 5a shows an embodiment of a notification apparatus 5 in the form of an augmented reality head-up display (AR-HUD), which is designed to inform the driver of the vehicle 1 about the predicted lateral distance 13 and/or the actual lateral distance. To this end, a (white) signal light 14 is displayed (represented by hatching) in the lower left edge of the notification apparatus 5 or augmented reality head-up display (AR-HUD). The (white) signal light 14 can signal to the driver of the vehicle 1 that, for example, based on a current position of the vehicle 1 and/or based on the steering angle, the predicted lateral distance 13 is too great for optimum travel on the travel path 9 described by the ideal-line data.

FIG. 5b likewise shows a schematic representation of a driver's view at the entrance to the bend according to FIG. 3. This is comparable to the representation already given in FIG. 4 and FIG. 5a. Unlike FIG. 5a, however, in FIG. 5b a (green) signal light 15 (represented by denser hatching) signals to the driver of the vehicle a small predicted lateral distance 13. The (green) light signal 15 in this case can notify the driver of the vehicle 1 of optimum travel on the travel path 9 described by the ideal-line data, and thus give the driver positive feedback.

FIG. 5c shows, analogous to FIG. 5b, a schematic representation of a driver's view at the apex. The (green) signal light 15 (represented by dense hatching) can be displayed at the lower right edge of the notification apparatus 5 or augmented reality head-up display (AR-HUD). The driver of the vehicle can be notified thereby of a low predicted lateral distance 13 and/or actual lateral distance from the characteristic route-course point 12 lying at the apex of the bend of the predetermined route course 10. The (green) light signal 15 can again in this case notify the driver of the vehicle 1 of optimum travel on the travel path 9 described by the ideal-line data, and thus give the driver positive feedback.

1.-9. (canceled)

10. A method for assisting a driver of a vehicle when traveling on a predetermined route course in road traffic, the method comprising:
receiving ideal-line data, which describes a travel path of the vehicle in a region of the predetermined route course, wherein the travel path runs within a lane;
receiving surroundings data, which describes a surrounding area of the vehicle, through which surrounding area runs the travel path described by the ideal-line data;
determining at least one characteristic route-course point based on the ideal-line data and the surroundings data;
localizing the at least one characteristic route-course point in terms of a relative position of the vehicle; and
providing relative-position data, which describes the relative position of the vehicle in relation to the at least one characteristic route-course point;
wherein the providing of the relative-position data is performed in such a way that the relative-position data describes the relative position of the vehicle in relation to the at least one characteristic route-course point based on a predicted lateral distance; and
wherein the predicted lateral distance describes a distance between the vehicle and the at least one characteristic route-course point expected between the vehicle and the at least one characteristic route-course point when the at least one characteristic route-course point is passed.

11. The method according to claim 10, wherein feedback data, which describes the passing of the at least one characteristic route-course point, is provided.

12. The method according to claim 11, wherein the feedback data also describes an actual lateral distance between the vehicle and the at least one characteristic route-course point when the at least one characteristic route-course point is passed.

13. A computing device for a vehicle, the computing device being configured to perform a method according to claim 10.

14. A non-transitory computer-readable storage medium comprising commands which, on execution by a computing device, cause the computing device to perform a method according to claim 10.

15. An assistance system for a vehicle, the assistance system comprising:
a computing device configured to execute a program to:
receive ideal-line data, which describes a travel path of the vehicle in a region of the predetermined route course, wherein the travel path runs within a lane;
receive surroundings data, which describes a surrounding area of the vehicle, through which surrounding area runs the travel path described by the ideal-line data;
determine at least one characteristic route-course point based on the ideal-line data and the surroundings data;
localize the at least one characteristic route-course point in terms of a relative position of the vehicle; and
provide relative-position data, which describes the relative position of the vehicle in relation to the at least one characteristic route-course point;
wherein the relative-position data is provided in such a way that the relative-position data describes the relative position of the vehicle in relation to the at least one characteristic route-course point based on a predicted lateral distance; and
wherein the predicted lateral distance describes a distance between the vehicle and the at least one characteristic route-course point expected between the vehicle and the at least one characteristic route-course point when the at least one characteristic route-course point is passed;
a non-transitory computer-readable storage medium in which the program is stored;
a notification apparatus configured to inform a driver of the vehicle, based on the relative-position data and/or the feedback data, about the predicted lateral distance and/or the actual lateral distance and/or about the passing of the at least one characteristic route-course point.

16. The assistance system according to claim 15, wherein the notification apparatus includes at least one of an acoustic notification apparatus, a visual notification apparatus, and a haptic notification apparatus.

17. The assistance system according to claim 15, wherein the notification apparatus is configured to inform the driver about the predicted lateral distance and/or the actual lateral distance via simulated road feedback.

18. The assistance system according to claim 16, wherein the notification apparatus is configured to inform the driver about the predicted lateral distance and/or the actual lateral distance via simulated road feedback.

19. The assistance system according to claim 15, further comprising a driving-style analysis apparatus, which is configured to record and/or analyze the relative-position data and/or the feedback data during travel on the predetermined route course.

20. The assistance system according to claim 16, further comprising a driving-style analysis apparatus, which is configured to record and/or analyze the relative-position data and/or the feedback data during travel on the predetermined route course.

21. The assistance system according to claim 17, further comprising a driving-style analysis apparatus, which is configured to record and/or analyze the relative-position data and/or the feedback data during travel on the predetermined route course.
